(19) United States
(12) Patent Application Publication
(10) Pub. No.: US 2008/0014924 A1
(43) Pub. Date: Jan. 17, 2008

(54) DUAL MODE DECODER OPERABLE WITH EXTERNAL MEMORY

(75) Inventors: Anuj Batra, Dallas, TX (US); Srinivas Lingam, Dallas, TX (US)

Correspondence Address: TEXAS INSTRUMENTS INCORPORATED, P O BOX 655474, M/S 3999, DALLAS, TX, 75265, US

(73) Assignee: Texas Instruments, Inc., Dallas, TX (US)

(21) Appl. No.: 11/548,901

(22) Filed: Oct. 12, 2006

Related U.S. Application Data
(60) Provisional application No. 60/725,695, filed on Oct. 12, 2005.

(51) Int. Cl. H04Q 7/20

(52) U.S. Cl. 455/426.1

(57) ABSTRACT

A dual mode decoder operable with external memory. At least some of the illustrative embodiments are integrated circuit products comprising a processor portion, a memory portion coupled to the processor portion, and a hardware demodulation portion coupled to the processor portion. The processor portion and hardware demodulation portion work together to demodulate a first digital transmission signal created utilizing a first modulation system, and the processor portion and hardware demodulation portion work together to decode a second digital transmission signal created using a second modulation system different than the first modulation system (the second digital signal having at least one time interleaved segment). The integrated circuit product couples to an external memory for purposes of time de-interleaving when an amount of memory of the memory portion is insufficient for time de-interleaving for a number of segments of the second digital transmission signal.

### CROSS-REFERENCE TO RELATED APPLICATIONS

This application claims the benefit of Provisional Application Ser. No. 60/725,695 filed Oct. 12, 2005 entitled “External Memory for Time Interleaver of ISDB-T,” and the application is incorporated by reference herein as if reproduced in full below.

### BACKGROUND

With the advent of mobile devices capable of displaying video, several encoding standards have arisen to meet needs specific to broadcasting video, along with other non-video data, to the mobile devices. For example, the European Television Standards Institute (ETSI) has developed a Digital Video Broadcasting to Handheld terminals (DVB-H) standard. In order to address “bursty” errors in transmission, the DVB-H standard defines the use of forward error correction for multiprotocol encapsulated data (MPE-FEC).

Another example of a broadcasting standard to meet needs specific to broadcasting video and other non-video data to mobile devices is the Terrestrial Integrated Services Digital Broadcasting (ISDB-T) standard in use in Japan. The ISDB-T standard defines thirteen segments within the transmission band, each segment being a band within which data may be modulated using orthogonal frequency division multiplexing. However, one need not modulate within all thirteen segments, with the standard defining use with less than all thirteen, including use of only a single segment. Rather than MPE-FEC to address bursty errors in the transmission medium, the ISDB-T standard defines the use of time interleaving to address bursty errors. The amount of memory needed to time de-interleave a received signal varies proportionally to the number of segments utilized.

Having an application specific integrated circuit (ASIC) with sufficient memory to time de-interleave a thirteen segment ISDB-T transmission when fewer segments are actually used may make the ASIC cost and size prohibitive for most mobile devices. Moreover, having individual ASICs for each transmission standard limits flexibility and the potential markets for the ASICs.

### SUMMARY

The problems noted above are solved in large part by a dual mode decoder operable with external memory. At least some of the illustrative embodiments are integrated circuit products comprising a processor portion, a memory portion coupled to the processor portion, and a hardware decoder portion coupled to the processor portion. The processor portion and hardware decoder portion work together to decode a first digital transmission signal created utilizing a first encoding system, and the processor portion and hardware decoder portion work together to decode a second digital transmission signal created using a second encoding system different than the first encoding system (the second digital signal having at least one time interleaved segment). The integrated circuit product couples to an external memory for purposes of time de-interleaving when an amount of memory of the memory portion is insufficient for time de-interleaving for a number of segments of the second digital transmission signal.

### BRIEF DESCRIPTION OF THE DRAWINGS

For a detailed description of exemplary embodiments, reference will now be made to the accompanying drawings in which:

FIG. 1 shows a mobile electronic device in accordance with at least some embodiments; and

FIG. 2 shows an ASIC in accordance with at least some embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct connection, or through an indirect connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

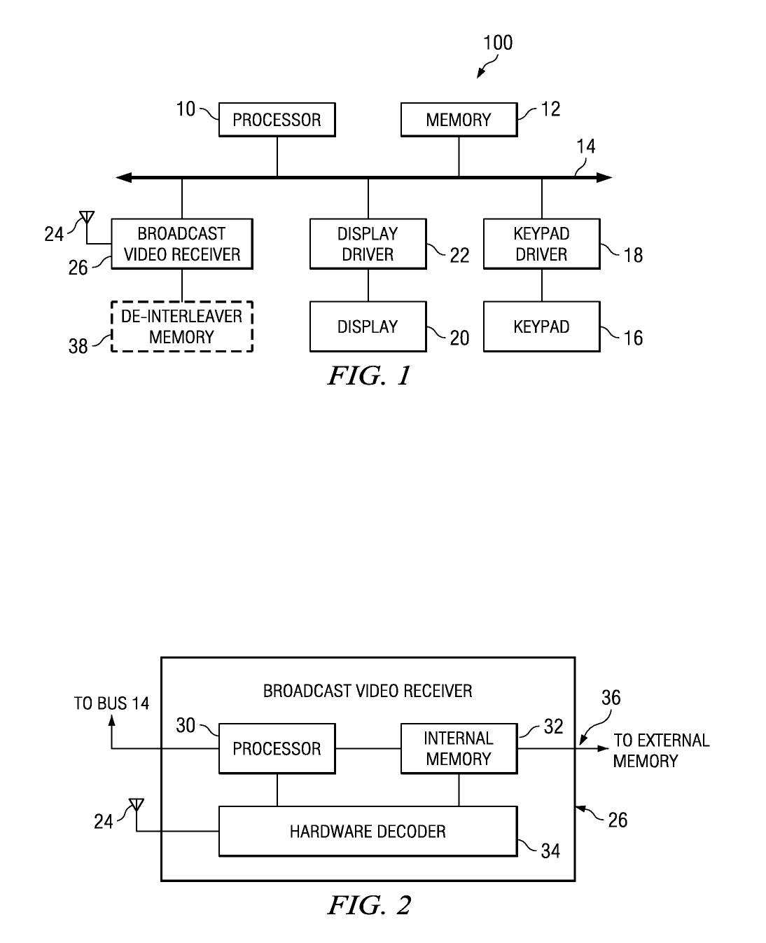

FIG. 1 illustrates a mobile electronic device 100 in accordance with at least some embodiments. In particular, the mobile electronic device 100 comprises a processor 10 coupled to a memory 12 by way of a bus 14. The processor 10 may be any currently available or after-developed processor suitable for operation in mobile devices. In some embodiments, memory 12 is dynamic random access memory (DRAM), or any of the variants of DRAM such as synchronous DRAM (SDRAM). In other embodiments, the memory 12 may be a non-volatile memory, such as an electrically erasable programmable read only memory (EEPROM) or non-volatile magnetic memory.

In order to interface with a human operator, the mobile electronic device may further comprise a keyboard or key pad 16 that couples to the processor 10 by way of a keypad driver 18. In embodiments where the mobile electronic device 101 is a mobile telephone, the keypad 16 is a twelve key numeric keypad. In embodiments where the mobile electronic device is a wireless messaging device, the key pad 16 is a reduced size alpha-numeric keypad. In embodiments were the mobile electronic device is a laptop or notebook computer, the keypad 16 is a full or reduced size alpha-numeric keyboard. In embodiments where the mobile electronic device is a personal portable media player (e.g., a MPEG, MC, AVC, H.264, Windows video or MP3 player), the keypad 16 may be circular user interface.

The mobile electronic device 100 further comprises a display device 20 coupled to the processor 10 and memory 12 through a display driver 22. Contents of the display may be modified by manipulating display memory in either the memory 12 and/or in memory of the display driver 22. In cases where the mobile electronic device 100 is a mobile telephone, wireless messaging device or a personal music player, the display device 20 may be a relatively small (e.g., one to five inch diagonal) color liquid crystal display (LCD). In embodiments where the mobile electronic device is a laptop or notebook computer, the display device 20 may be a relatively large (e.g., 15 inch diagonal) color liquid crystal display.

In accordance with at least some embodiments, the mobile electronic device 100 may be used in geographic areas where video is broadcast, and in some cases the video may be specifically targeted to mobile electronic devices. Thus, mobile electronic device 100 may further comprise an antenna 24 coupled to a broadcast video receiver 26. Video received by the antenna 24 and demodulated by the broadcast video receiver 26 may then couple to the processor 10, the memory 12 and/or the display driver 22 for display on the display device 20.

In order to address concerns specific to receiving and displaying video on mobile electronic devices (in addition to non-video data transfer) several encoding standards have arisen. For example, the European Television Standards Institute (ETSI) has developed a Digital Video Broadcasting to Handheld terminals (DVB-H) standard ETSI EN 302 304. DVB-H uses forward error correction for multiprotocol encapsulated data (MPE-FEC) to address “bursty” errors in transmission, and thus need not implement time interleaving as part of the modulation process (although other interleaving (e.g., bit and symbol) may be used). Correspondingly, a demodulator under the DVB-H standard need not implement a time de-interleaver.

Another example of a broadcasting standard to meet needs specific to broadcasting motion video to mobile devices is the Terrestrial Integrated Services Digital Broadcasting (ISDB-T) standard in use in Japan. Within the bandwidth of a channel, an ISDB-T compliant system may have up to thirteen individual segments within which orthogonal frequency division multiplexing (OFDM) may be used. Thus, some ISDB-T systems may utilize only one segment, other ISDB-T systems may utilize three segments, and yet still others may utilize anywhere from three to thirteen segments. Rather than using MPE-FEC to address bursty errors in the transmission medium, the ISDB-T standard defines the use of time interleaving. With respect to decoding ISDB-T compliant signals, the amount of memory needed to time de-interleave varies proportionally to the number of segments utilized.

Returning to FIG. 1, in accordance with embodiments of the invention the broadcast video receiver 26 is designed and constructed to demodulate multiple signals from multiple encoding systems. For example, receiver 26 in accordance with some embodiments is configured to demodulate signals modulated using the DVB-H standard, and is also configured to demodulate signals using the ISDB-T standard. In this way a single broadcast video receiver design (e.g., in the form of an application specific integrated circuit (ASIC)) may find use in multiple types of mobile electronic devices 100, including mobile electronic devices to be operated in geographic locations operating under different standards for the broadcast of video.

FIG. 2 illustrates in greater detail the broadcast video receiver 26 in accordance with at least some embodiments. In particular, the receiver 26 comprises a processor portion 30. The processor portion 30 may be a register- and/or stack-based processor that executes instructions. The instructions executed may be executed from the internal memory 32 coupled to the processor 30. The receiver 26 may further comprise a hardware decoder portion 34 which couples at least to the processor portion 30. Thus, the processor portion 30 (executing instructions from and operating on data structures in the internal memory 32) works together with the hardware decoder portion 34 to demodulate digital transmission signals modulated using various encoding schemes.

In accordance with some embodiments, the processor portion 30 and hardware decoder 34 work together to demodulate digital transmission signals modulated using the DVB-H standard, and also work together to demodulate digital transmission signal modulated using the ISDB-T standard, though the decoding of the signals using different standards may not necessarily take place simultaneously. Whether the broadcast video receiver 26 attempts to demodulate signals as DVB-H signals or ISDB-T signals is dependent upon the geographic location of use of the mobile electronic device and/or how the receiver 26 is configured. Configuring receiver 26 to demodulate the illustrative DVB or ISDB signals may be accomplished by way of software routines (e.g., writing a particular value to a register of the processor or other location in the receiver 26), by hardware (e.g., hardware jumper settings), or a combination of both. It is noted that having a receiver 26 that demodulates either under the DVB-H standard or the ISDB-T standard is merely illustrative. The receiver 26 may be configured to demodulate signals modulated using any currently available or after-developed encoding standard.

As mentioned above, the illustrative DVB-H standard uses MPE-FEC as the mechanism to combat bursty errors introduced in the transmission of digital video signals. The illustrative ISDB-T standard, by contrast, uses time interleaving as the mechanism to combat bursty errors introduced in the transmission of the digital video signals. Time interleaving as part of encoding dictates the use of time de-interleaving as part of decoding. Time de-interleaving is a memory intensive operation as all the parameters to de-interleave are held in a memory during the de-interleaving process. Thus, as the number of segments in the illustrative ISDB-T standard increases, the amount of memory needed to time de-interleave the signal likewise increases, with ISDB-T defining up to 13 segments. While it is possible to design a demodulator of a broadcast video receiver 26 with sufficient memory to demodulate a 13 segment ISDB-T signal, the physical size of such an ASIC limits its use. Moreover, an ASIC with sufficient internal memory to time de-interleave a 13 segment ISDB-T signal may be cost prohibitive in systems where fewer segments are used.

In order to address such concerns, and in accordance with embodiments of the invention, the broadcast video receiver 26 internal memory 32 is sized to accommodate decoding the MPE-FEC signals of a DVB-H and to accommodate time de-interleaving of less than all 13 possible segments in an ISDB-T signal. Decoding MPE-FEC signals utilizes approximately 2 Mega-bits (Mbits) of internal memory space. Time de-interleaving of ISDB-T signals utilizes approximately 1.75 Mbits for each segment at 64 bit quadrature amplitude modulation (QAM), and uses approximately 1.167 Mbits for each segment at 16 bit QAM. Thus, in accordance with some embodiments, the receiver 26 implements internal memory on the order of approximately 2 Mbits, which enables the ASIC to demodulate DVB-H signals as well as one segment ISDB-T signals. In alternative embodiments, the receiver 26 implements approximately 5.25 Mbits, such that there is sufficient internal memory to demodulate the DVB-H signals as well as a three segment ISDB-T signal at 64 bit QAM or a four segment ISDB-T signal at 16 bit QAM.

However, there may be situations where the broadcast video receiver 26 is used in systems where more than one or three segment ISDB-T is used. In such situations, an in accordance with embodiments of the invention, the receiver 26 is further configured to couple to external memory such that overall memory size is increased to accommodate more segments in the ISDB-T signal. FIG. 2 illustrates an ability of the receiver 26 to couple to external memory by memory bus 36. Memory bus 36 may comprise, in some embodiments, a 24 pin bus (8 data lines, 13 address lines, a clock line, an enable line and a read/write line); however, any currently available or after-developed bus system for communicating with a memory device may be equivalently used. FIG. 1 illustrates an ability of the receiver 26 to couple to external memory by showing the receiver 26 coupled to external de-interleaver memory 38 (shown in dashed lines to highlight the optional use). Thus, in mobile electronic devices 100 where the amount of internal memory 32 is sufficient to time de-interleave a received digital signal, the receiver 26 may be implemented without the de-interleaver memory 38. In mobile electronic devices 100 where the amount of internal memory 32 is insufficient to time de-interleave a received digital signal, the receiver 26 may couple to the additional de-interleaver memory 38. When using the external de-interleaver memory 38, the data may be split between the internal memory 32 (FIG. 2) and the external memory 38 (FIG. 1), or the data may reside solely within the external memory 38. If the number of segments or other parameters change such that internal memory 32 is sufficient for time de-interleaving, the external memory 38, though present, may be ignored.

The above discussion is meant to be illustrative of the principles and various embodiments of the present invention. Numerous variations and modifications will become apparent to those skilled in the art once the above disclosure is fully appreciated. For example, while the various embodiments are described in terms of a mobile electronic device, the methods and systems are equally applicable to devices considered non-mobile, such as television sets that do not implement operation from battery power. Moreover, while some of the embodiments are discussed in terms of DVB-H and ISDB-T signals, these encoding schemes are merely illustrative, and other encoding schemes (e.g. DBH-T used in China) may be equivalently implemented. The internal/external memory dichotomy is applicable to any decoding system where time de-interleaving is used. It is intended that the following claims be interpreted to embrace all such variations and modifications.

What is claimed is:

1. An integrated circuit product comprising:
a processor portion;
a memory portion coupled to the processor portion;
a hardware decoder portion coupled to the processor portion;
the processor portion and hardware decoder portion work together to demodulate a first digital transmission signal created utilizing a first modulation system;
the processor portion and hardware decoder portion work together to demodulate a second digital transmission signal created using a second modulation system different than the first modulation system, the second digital signal having at least one time interleaved segment;
the integrated circuit product couples to an external memory for purposes of time de-interleaving when an amount of memory of the memory portion is insufficient for time de-interleaving for a number of segments of the second digital transmission signal.

2. The integrated circuit product as defined in claim 1 wherein processor portion and hardware decoder portion mutually exclusively demodulate the first digital transmission signal and the second digital transmission signal.

3. The integrated circuit product as defined in claim 1 wherein the first modulation system is a Digital Video Broadcast (DVB) standard of the European Television Standards Institute (ETSI).

4. The integrated circuit product as defined in claim 3 wherein the second modulation system is an Integrated Services Digital Broadcasting (ISDB) standard.

5. The integrated circuit product as defined in claim 1 wherein the second modulation system is an Integrated Services Digital Broadcasting-Terrestrial (ISDB-T) standard.

6. The integrated circuit product as defined in claim 1 wherein the memory portion is of sufficient size to time de-interleave the second digital transmission signal having only one segment.

7. The integrated circuit product as defined in claim 6 wherein the integrated circuit product couples to the external memory when the second digital transmission signal comprises more than one segment.

8. The integrated circuit product as defined in claim 1 wherein the memory portion is of sufficient size to time de-interleave the second digital transmission signal having at least three segments.

9. The integrated circuit product as defined in claim 8 wherein the integrated circuit product couples to the external memory when the second digital transmission signal comprises more than three segments.

10. The integrated circuit product as defined in claim 1 wherein the integrated circuit product is configured to demodulate a signal of the first or second modulation system based on at least one selected from the group consisting of: a value written to a register internal to the integrated circuit product; the setting of a hardware jumper coupled to the integrated circuit; and a combination of the register value and the hardware jumper.

11. A system comprising:
a display that displays video;
a broadcast video receiver coupled to the display, the broadcast video receiver demodulates video that is then shown on the display;
the broadcast video receiver comprising:
a processor portion;
a memory portion coupled to the processor portion;
a hardware decoder portion coupled to the processor portion;
the processor portion and hardware decoder portion work together to demodulate a first video transmission signal created utilizing a first modulation system;
the processor portion and hardware decoder portion work together to demodulate a second video transmission signal created using a second modulation system different than the first modulation system, the second video signal having at least one time interleaved segment;
the decoder couples to an external memory, external to the decoder but internal to the system, to time de-interleave the second video signal when an amount of memory of the memory portion is insufficient for time de-interleaving for a number of segments of the second video transmission signal.

12. The system as defined in claim 11 wherein the system further comprises a mobile electronic device.

13. The system as defined in claim 12 wherein the mobile electronic device further comprises at least one selected from the group consisting of: a mobile telephone; a notebook computer; a portable television; or a personal portable media player.

14. The system as defined in claim 11 wherein the system further comprises an antenna coupled to the broadcast video receiver.

15. The system as defined in claim 11 wherein the first encoding system is a Digital Video Broadcast (DVB) standard of the European Television Standards Institute (ETSI).

16. The integrated circuit product as defined in claim 15 wherein the second modulation system system is an Integrated Services Digital Broadcasting (ISDB) standard.

17. The integrated circuit product as defined in claim 11 wherein the second modulation system is an Integrated Services Digital Broadcasting-Terrestrial (ISDB-T) standard.

18. An integrated circuit device comprising:
a means for executing programs to at least partially demodulate at least one selected from the group consisting of: a first digital transmission signal modulated using a first modulation system; or a second digital transmission signal modulated using a second modulation system different from the first modulation system;
an internal means for storing data and instructions coupled to the means for executing;
a means for hardware demodulation coupled to the means for executing, the means for hardware demodulation at least partially demodulations at least one selected from the group consisting of: a first digital transmission signal modulated using a first modulation system; or a second digital transmission signal modulation using a second modulation system different from the first modulation system;
the integrated circuit device couples to an external means for storing data and instructions for purposes of time de-interleaving when an amount of memory of the internal means for storing is insufficient for time de-interleaving for a number of segments of the second digital transmission signal.

19. The integrated circuit product as defined in claim 18 wherein means for executing and the means for hardware demodulation mutually exclusively demodulate the first digital transmission signal and the second digital transmission signal.

20. The integrated circuit product as defined in claim 18 wherein the first modulation system is a Digital Video Broadcast (DVB) standard of the European Television Standards Institute (ETSI).

21. The integrated circuit product as defined in claim 20 wherein the second modulation system is an Integrated Services Digital Broadcasting (ISDB) standard.

22. The integrated circuit product as defined in claim 18 wherein the second modulation system is an Integrated Services Digital Broadcasting-Terrestrial (ISDB-T) standard.

23. The integrated circuit product as defined in claim 18 wherein the internal means for storing data and instructions is of sufficient size to time de-interleave the second digital transmission signal having only one segment.

24. The integrated circuit product as defined in claim 23 wherein the integrated circuit product couples to the external means for storing data and instructions when the second digital transmission signal comprises more than one segment.

25. The integrated circuit product as defined in claim 18 wherein the internal means for storing data and instructions is of sufficient size to time de-interleave the second digital transmission signal having only three segments.

26. The integrated circuit product as defined in claim 25 wherein the integrated circuit product couples to the external means for storing data and instructions when the second digital transmission signal comprises more than three segments.
